(19) United States
(12) Patent Application Publication
(10) Pub. No.: US 2018/0029585 A1
(43) Pub. Date: Feb. 1, 2018

(54) VEHICLE CONTROLLER, VEHICLE, AND CONTROL SYSTEM

(71) Applicant: TOYOTA JIDOSHA KABUSHIKI KAISHA, Toyota-shi (JP)

(72) Inventor: Mitsutaka TANIMOTO, Numazu-shi (JP)

(73) Assignee: TOYOTA JIDOSHA KABUSHIKI KAISHA, Toyota-shi (JP)

(21) Appl. No.: 15/653,303

(22) Filed: Jul. 18, 2017

(30) Foreign Application Priority Data
Aug. 1, 2016 (JP) 2016-151346

(51) Int. Cl. B60W 10/20; B60W 30/02; B60W 30/18; B60W 30/12

(52) U.S. Cl. CPC B60W 10/20; B60W 30/12; B60W 30/02; B60W 30/18109; B60W 2710/182; B60W 2720/14

(57) ABSTRACT

A vehicle controller performs traveling control of a vehicle. The traveling control includes lane departure prevention control of turning the vehicle in a direction in which lane departure of the vehicle is avoided and roll stiffness control of changing a roll stiffness of the vehicle. The vehicle controller executes the roll stiffness control by coupling with execution of the lane departure prevention control.

### INCORPORATION BY REFERENCE

The disclosure of Japanese Patent Application No. 2016-151346 filed on Aug. 1, 2016 including the specification, drawings and abstract is incorporated herein by reference in its entirety.

### BACKGROUND

### 1. Technical Field

The disclosure relates to a vehicle and a vehicle controller and a control system that perform traveling control of a vehicle. Particularly, the disclosure relates to a vehicle, a vehicle controller, and a control system that execute lane departure prevention control.

### 2. Description of Related Art

“Lane departure prevention control” for preventing lane departure of a vehicle is known. Specifically, a controller for a vehicle detects a state in which a driver does not intend to change a traveling lane but the vehicle is likely to depart from the traveling lane. When such a state is detected, the controller automatically turns the vehicle in a direction in which lane departure is avoided. This control is called lane departure alert (LDA) or lane keeping assist (LKA).

Japanese Patent Application Publication No. 2006-282168 (JP 2006-282168 A) discloses lane departure prevention control based on brake control. According to this control, a controller generates a difference in braking force between right and left wheels in order to turn the vehicle in a direction in which lane departure is avoided.

Japanese Patent Application Publication No. 2010-100120 (JP 2010-100120 A) discloses lane departure prevention control using an electric power steering (EPS) device. According to this control, a controller applies a steering torque using the electric power steering device in order to turn the vehicle in a direction in which lane departure is avoided.

### SUMMARY

There is room for further improvement in lane departure prevention control. The disclosure provides a technique capable of controlling behavior of a vehicle more finely than in existing lane departure prevention control.

Since the lane departure prevention control operates regardless of a driver's intention, the lane departure prevention control causes the driver to feel discomfort depending on situations. For example, in a case of lane departure prevention control based on brake control, a vehicle is decelerated even when the driver does not depress a brake pedal. This deceleration causes discomfort to the driver. In a case of lane departure prevention control based on application of a steering torque, the steering torque is transmitted to a driver's hand gripping a steering wheel. The driver feels a torque different from a road-surface reaction force, which serves as discomfort. When a degree of turning of the vehicle increases due to the lane departure prevention control, a lateral acceleration and a roll angle increase. The driver feels roll behavior which does not correspond to steering, which serves as discomfort.

The disclosure also provides a technique capable of reducing discomfort due to lane departure prevention control.

A first aspect of the disclosure relates to a vehicle controller. The vehicle controller includes at least one electronic control unit configured to execute: lane departure prevention control of controlling a first actuator such that a vehicle is turned in a direction in which lane departure of the vehicle is avoided; and roll stiffness control of controlling a second actuator such that a roll stiffness of the vehicle is changed, wherein the at least one electronic control unit executes the roll stiffness control by coupling with execution of the lane departure prevention control.

A second aspect of the disclosure relates to a vehicle. The vehicle includes: a lane departure prevention device that executes lane departure prevention control of turning the vehicle in a direction in which lane departure of the vehicle is avoided; and a roll stiffness control device that executes roll stiffness control of changing a roll stiffness of the vehicle, wherein the roll stiffness control device executes the roll stiffness control by coupling with execution of the lane departure prevention control by the lane departure prevention device.

A third aspect of the disclosure relates to a control system that executes traveling control of a vehicle. The control system includes: a first actuator configured to turn the vehicle; a second actuator configured to change a roll stiffness of the vehicle; and at least one electronic control unit configured to control the first actuator such that the vehicle is turned in a direction in which departure of the vehicle from a traveling lane is avoided, and control the second actuator by coupling with control of the first actuator.

According to the above aspects of the disclosure, the roll stiffness control is executed by coupling with the lane departure prevention control. The lane departure prevention control is for turning the vehicle and the roll stiffness control affects steering characteristics of the vehicle. Accordingly, by combining the roll stiffness control with the lane departure prevention control, it is possible to control behavior of a vehicle more finely than in existing lane departure prevention control.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating an example of a configuration of a vehicle according to an embodiment of the disclosure;

FIG. 2 is a conceptual diagram illustrating lane departure prevention control;

FIG. 3 is a flowchart illustrating an example of the lane departure prevention control;

FIG. 4A is a conceptual diagram illustrating a relationship between a roll stiffness distribution and steering characteristics;

FIG. 4B is a conceptual diagram illustrating a relationship between a roll stiffness distribution and steering characteristics;

FIG. 4C is a conceptual diagram illustrating a relationship between a roll stiffness distribution and steering characteristics;

FIG. 5 is a graph illustrating a relationship between a cornering power and a load;

FIG. 6 is a block diagram illustrating functions of a controller according to the embodiment;

FIG. 7 is a flowchart illustrating a process flow in the controller according to the embodiment in brief;

FIG. 8 is a timing chart illustrating roll stiffness control in a first example of traveling control according to the embodiment;

FIG. 9 is a conceptual diagram illustrating advantages achieved by the first example of the traveling control according to the embodiment;

FIG. 10 is a conceptual diagram illustrating lane departure prevention control in a second example of the traveling control according to the embodiment;

FIG. 11 is a timing chart illustrating lane departure prevention control in a third example of the traveling control according to the embodiment;

FIG. 12 is a timing chart illustrating roll stiffness control in a fourth example of the traveling control according to the embodiment;

FIG. 13 is a flowchart illustrating the roll stiffness control in the fourth example of the traveling control according to the embodiment;

FIG. 14 is a flowchart illustrating roll stiffness control in a fifth example of the traveling control according to the embodiment; and

FIG. 15 is a timing chart illustrating the roll stiffness control in the fifth example of the traveling control according to the embodiment.

### DETAILED DESCRIPTION OF EMBODIMENTS

An embodiment of the disclosure will be described below with reference to the accompanying drawings.

### 1. Example of Configuration

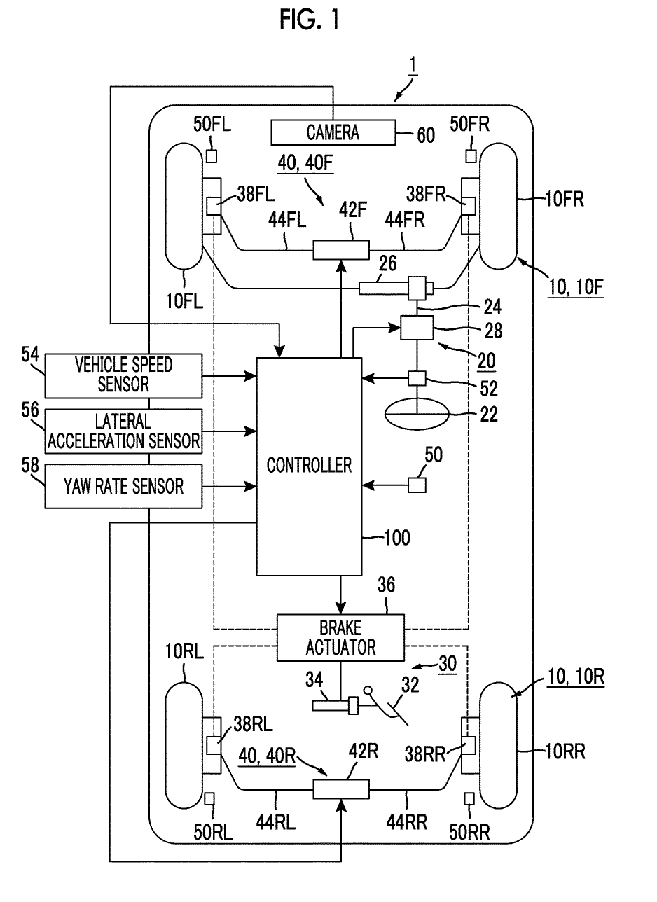

FIG. 1 is a diagram schematically illustrating an example of a configuration of a vehicle 1 according to an embodiment of the disclosure. The vehicle 1 includes wheels 10, a steering mechanism 20, a brake mechanism 30, a roll stiffness varying mechanism 40, various sensors, a camera unit 60, and a controller 100.

<Wheels 10>

The wheels 10 include a front-left wheel 10FL, a front-right wheel 10FR, a rear-left wheel 10RL, and a rear-right wheel 10RR. In the following description, the front-left wheel 10FL and the front-right wheel 10FR may be referred to as “front wheels 10F,” and the rear-left wheel 10RL and the rear-right wheel 10RR may be referred to as “rear wheels 10R.”

<Steering Mechanism 20>

The steering mechanism 20 is an electric power steering (EPS) mechanism. More specifically, the steering mechanism 20 includes a steering wheel 22, a steering shaft 24, a steering gear 26, and an electric actuator 28.

The steering wheel 22 is an operation member which is used for a driver to perform a steering operation. The steering shaft 24 connects the steering wheel 22 and the steering gear 26 to each other and transmits a rotational motion of the steering wheel 22 to the steering gear 26. The steering gear 26 is connected to the front wheels 10F via a link mechanism and converts the rotational motion input from the steering shaft 24 into a motion of the link mechanism. A direction of the front wheels 10F, that is, a traveling direction of the vehicle 1, can be changed by the motion of the link mechanism.

The electric actuator 28 includes an electric motor and generates a steering torque by rotation of the electric motor. The electric actuator 28 applies the generated steering torque to the steering shaft 24 or the steering gear 26. The generation of the steering torque from the electric actuator 28 may be coupled with the driver's steering operation using the steering wheel 22 or may be independent therefrom. By generating the steering torque by coupling with the driver's steering operation, it is possible to assist the steering operation. On the other hand, by generating the steering torque independently from the driver's steering operation, for example, it is possible to automatically control a posture of the vehicle 1.

<Brake Mechanism 30>

The brake mechanism 30 includes a brake pedal 32, a master cylinder 34, a brake actuator 36, and wheel cylinders 38FL, 38FR, 38RL, and 38RR.

The brake pedal 32 is an operation member which is used for a driver to perform a braking operation. The master cylinder 34 is connected to the wheel cylinders 38FL, 38FR, 38RL, and 38RR via the brake actuator 36. The wheel cylinders 38FL, 38FR, 38RL, and 38RR are disposed in the front-left wheel 10FL, the front-right wheel 10FR, the rear-left wheel 10RL, and the rear-right wheel 10RR, respectively.

The master cylinder 34 supplies a brake fluid with a pressure based on an amount by which the brake pedal 32 is operated by a driver to the brake actuator 36. The brake actuator 36 distributes the brake fluid from the master cylinder 34 to the wheel cylinders 38FL, 38FR, 38RL, and 38RR. Braking forces generated in the front-left wheel 10FL, the front-right wheel 10FR, the rear-left wheel 10RL, and the rear-right wheel 10RR are determined depending on the pressures of the brake fluid supplied to the wheel cylinders 38FL, 38FR, 38RL, and 38RR.

The brake actuator 36 includes a valve or a pump and can independently adjust the pressures of the brake fluid supplied to the wheel cylinders 38FL, 38FR, 38RL, and 38RR. That is, the brake actuator 36 can independently control the braking forces of the front-left wheel 10FL, the front-right wheel 10FR, the rear-left wheel 10RL, and the rear-right wheel 10RR. The control of the braking forces by the brake actuator 36 may be coupled with the driver's braking operation using the brake pedal 32 or may be independent therefrom. By controlling the braking forces of the wheels 10 independently from the driver's braking operation, for example, it is possible to automatically control the posture of the vehicle 1.

<Roll Stiffness Varying Mechanism 40>

In this embodiment, a roll stiffness of the vehicle 1 is variable. The variable control of the roll stiffness is performed by the roll stiffness varying mechanism 40. More specifically, the roll stiffness varying mechanism 40 independently controls the roll stiffness of the front wheels 10F side and the roll stiffness of the rear wheels 10R side. Examples of the roll stiffness varying mechanism 40 include an active stabilizer and an active suspension.

In the example illustrated in FIG. 1, the roll stiffness varying mechanism 40 is an active stabilizer. Specifically, the roll stiffness varying mechanism 40 includes a front active stabilizer 40F of the front wheels 10F side and a rear active stabilizer 40R of the rear wheels 10R side

The front active stabilizer 40F adjusts the roll stiffness of the front wheels 10F side. More specifically, the front active stabilizer 40F includes an actuator 42F and stabilizer bars 44FL and 44FR. The stabilizer bar 44FL connects the actuator 42F to a support member of the front-left wheel 10FL. The stabilizer bar 44FR connects the actuator 42F to a support member of the front-right wheel 10FR. The actuator 42F includes a motor or a reduction gear. The actuator 42F can increase or decrease the roll stiffness of the front wheels 10F side by adjusting amounts of torsion of the stabilizer bars 44FL and 44FR.

The rear active stabilizer 40R adjusts the roll stiffness of the rear wheels 10R side. More specifically, the rear active stabilizer 40R includes an actuator 42R and stabilizer bars 44RL and 44RR. The stabilizer bar 44RL connects the actuator 42R to a support member of the rear-left wheel 10RL. The stabilizer bar 44RR connects the actuator 42R to a support member of the rear-right wheel 10RR. The actuator 42R includes a motor or a reduction gear. The actuator 42R can increase or decrease the roll stiffness of the rear wheels 10R side by adjusting amounts of torsion of the stabilizer bars 44RL and 44RR.

<Various Sensors>

Various sensors include a wheel speed sensor 50, a steering angle sensor 52, a vehicle speed sensor 54, a lateral acceleration sensor 56, and a yaw rate sensor 58.

The wheel speed sensor 50 includes wheel speed sensors 50FL, 50FR, 50RL, and 50RR which are disposed in the front-left wheel 10FL, the front-right wheel 10FR, the rear-left wheel 10RL, and the rear-right wheel 10RR, respectively. The wheel speed sensors 50FL, 50FR, 50RL, and 50RR detect rotation speeds of the front-left wheel 10FL, the front-right wheel 10FR, the rear-left wheel 10RL, and the rear-right wheel 10RR, respectively.

The steering angle sensor 52 detects a steering angle due to rotation of the steering wheel 22. The vehicle speed sensor 54 detects a speed of the vehicle 1. The lateral acceleration sensor 56 detects a lateral acceleration (lateral G) acting on the vehicle 1. The yaw rate sensor 58 detects an actual yaw rate which is generated in the vehicle 1.

<Camera Unit 60>

The camera unit 60 is used for lane departure prevention control to be described later. The camera unit 60 includes a camera that captures an image of a front side of the vehicle 1 and an image processing unit that processes imaging data. The image processing unit performs processing of the imaging data and extracts boundary lines such as a white line, a yellow line, and a center line on a road surface on the front side of the vehicle 1. The image processing unit recognizes a traveling lane based on the extracted boundary lines and generates traveling lane information indicating a relationship between the traveling lane and the position of the vehicle 1.

<Controller 100>

The controller 100 is a vehicle controller that performs traveling control of the vehicle 1. More specifically, the controller 100 is connected to various actuators (the electric actuator 28, the brake actuator 36, and the actuators 42F and 42R), various sensors, and the camera unit 60. The controller 100 receives detection information from various sensors and receives traveling lane information from the camera unit 60. The controller 100 activates necessary actuators to perform traveling control based on the received information.

For example, the controller 100 can perform “steering control” of applying a necessary steering torque by activating the electric actuator 28 of the steering mechanism 20. The controller 100 and the steering mechanism 20 can be said to constitute a “steering controller” that performs the steering control.

The controller 100 can perform “brake control” of applying a necessary braking force by activating the brake actuator 36 of the brake mechanism 30. The controller 100 and the brake mechanism 30 can be said to constitute a “brake controller” that performs the brake control.

The controller 100 can execute “roll stiffness control” of changing a roll stiffness of the vehicle 1 by activating the actuators 42F and 42R of the roll stiffness varying mechanism 40. The controller 100 and the roll stiffness varying mechanism 40 can be said to constitute a “roll stiffness controller” that executes the roll stiffness control.

Typically, the controller 100 is a microcomputer including a processor, a memory, and input and output interfaces. The controller 100 is also referred to as an electronic control unit (ECU). The controller 100 receives detection information from various sensors and transmits commands to various actuators via the input and output interfaces. A control program is stored in the memory, and the function of the controller 100 is realized by causing the processor to execute the control program.

### 2. Lane Departure Prevention Control

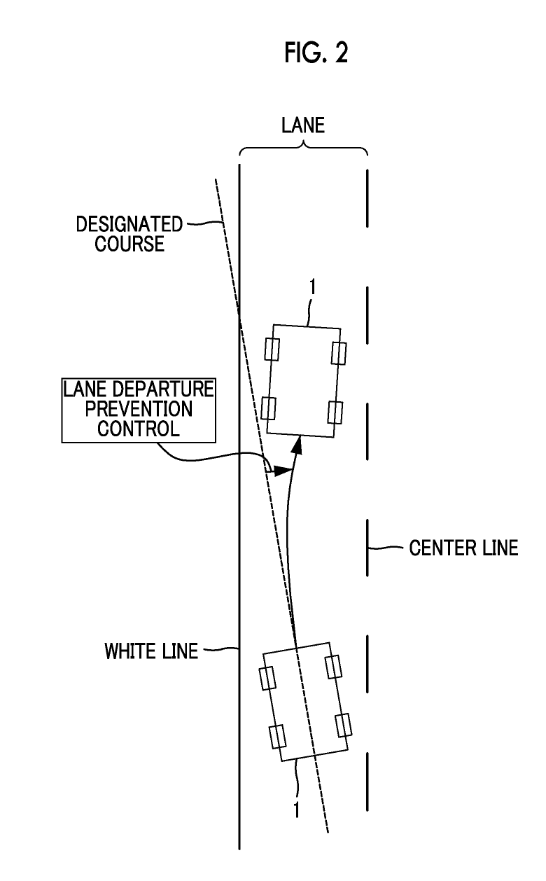

FIG. 2 is a conceptual diagram illustrating lane departure prevention control. A state in which a driver does not intend to change a traveling lane but the vehicle 1 is likely to depart from the traveling lane will be considered. In the lane departure prevention control, when such a state is detected, the vehicle 1 is automatically turned in a direction in which lane departure is avoided. This lane departure prevention control is also referred to as lane departure alert (LDA) or lane keeping assist (LKA).

The controller 100 according to this embodiment executes the lane departure prevention control. A specific method of the lane departure prevention control is not particularly limited. For example, a method disclosed in JP 2006-282168 A or JP 2010-100120 A may be used.

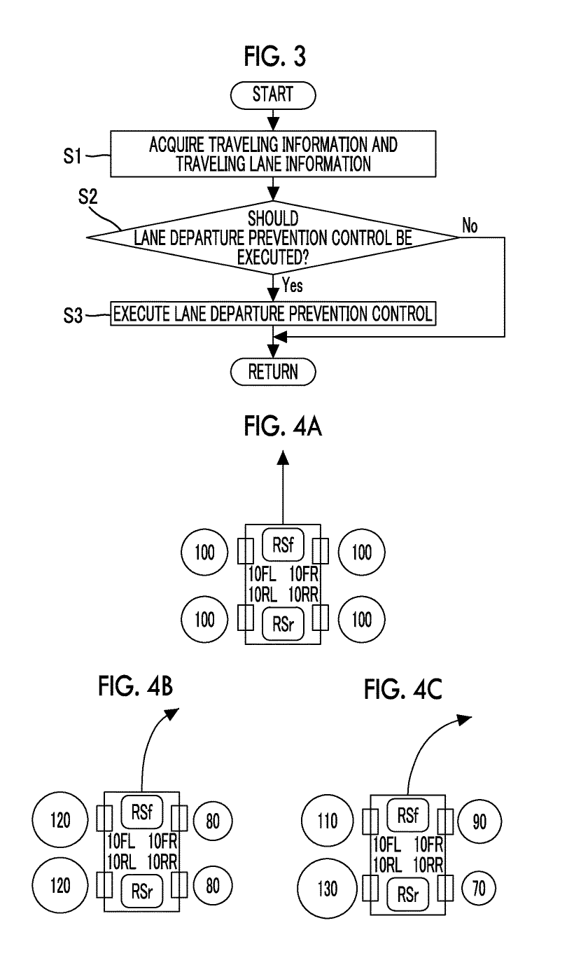

An example of the lane departure prevention control according to this embodiment will be described below. FIG. 3 is a flowchart illustrating an example of the lane departure prevention control. The flow illustrated in FIG. 3 is repeatedly performed while the vehicle 1 is traveling.

Step S1: The controller 100 receives traveling information from various sensors mounted in the vehicle 1. The traveling information includes rotation speeds of wheels detected by the wheel speed sensor 50, a steering angle detected by the steering angle sensor 52, a vehicle speed detected by the vehicle speed sensor 54, a lateral acceleration detected by the lateral acceleration sensor 56, and an actual yaw rate detected by the yaw rate sensor 58.

The camera unit 60 of the vehicle 1 captures an image of the front side of the vehicle 1. The camera unit 60 performs processing of the imaging data and extracts boundary lines such as a white line, a yellow line, and a center line on a road surface on the front side of the vehicle 1. The camera unit 60 recognizes a traveling lane based on the extracted boundary lines and generates traveling lane information indicating a relationship between the traveling lane and the position of the vehicle 1. The controller 100 receives the traveling lane information from the camera unit 60.

Step S2: The controller 100 determines whether to execute the lane departure prevention control based on the traveling information and the traveling lane information. For this purpose, the controller 100 determines (a) whether the vehicle 1 is likely to departure from the traveling lane and (b) whether a driver intends to actively change the traveling lane.

In Determination (a), the controller 100 estimates a course of the vehicle 1 in the traveling lane using the traveling information and the traveling lane information. Then, the controller 100 calculates a predicted time until the vehicle 1 departs from the traveling lane based on the traveling lane information, the estimated course, the vehicle speed, and the like. When the predicted time is less than an allowable value, the controller 100 determines that the vehicle 1 is likely to depart from the traveling lane.

In Determination (b), the controller 100 determines whether a driver performs a steering operation, for example, based on a change in the steering angle. When the driver does not perform the steering operation, the controller 100 can determine that the driver does not intend to actively change the traveling lane. A signal from a direction indicator which is not illustrated can also be used. When the driver does not operate the direction indicator, the controller 100 can determine that the driver does not intend to actively change the traveling lane.

When the driver does not intend to change the traveling lane but the vehicle 1 is likely to depart from the traveling lane, the controller 100 determines that the lane departure prevention control is executed (YES in Step S2). In this case, the flow transitions to Step S3. Otherwise (NO in Step S2), this cycle ends and the flow returns to Step S1.

Step S3: The controller 100 executes the lane departure prevention control. Specifically, the controller 100 automatically turns the vehicle 1 in a direction in which lane departure is avoided.

For example, the controller 100 can generate a steering torque and change the direction of the vehicle 1 by activating the electric actuator 28 of the steering mechanism 20. In the example illustrated in FIG. 2, in order to avoid lane departure, the controller 100 generates a steering torque to cause turning to right. The steering mechanism 20, the camera unit 60, and the controller 100 can be said to constitute a “lane departure prevention device” that executes the lane departure prevention control.

The controller 100 can also change the direction of the vehicle 1 by generating a difference in a braking force between the left wheels 10FL and 10RL and the right wheels 10FR and 10RR. For example, in the example illustrated in FIG. 2, in order to avoid lane departure, it is necessary to cause turning to right. For this purpose, the controller 100 can apply a braking force to the front-right wheel 10FR or both the front-right wheel 10FR and the rear-right wheel 10RR. Accordingly, a difference in braking force is generated between the right and left sides of the vehicle 1, and thus the vehicle 1 is turned to right. In order to control the braking forces of the wheels, the controller 100 can appropriately activate the brake actuator 36 of the brake mechanism 30. The brake mechanism 30, the camera unit 60, and the controller 100 can be said to constitute a “lane departure prevention device” that executes the lane departure prevention control.

### 3. Roll Stiffness Distribution and Steering Characteristics

A relationship between a roll stiffness distribution and steering characteristics will be described below with reference to FIGS. 4A to 4C. The roll stiffness distribution refers to distribution of the roll stiffness to the front wheels 10F side and the rear wheels 10R side of the vehicle 1. In FIGS. 4A to 4C, reference sign RSf denotes the roll stiffness on the front wheels 10F side and reference sign RSr denotes the stiffness on the rear wheels 10R side.

In FIGS. 4A to 4C, numerical values surrounded with circles are described beside the front-left wheel 10FL, the front-right wheel 10FR, the rear-left wheel 10RL, and the rear-right wheel 10RR. These numerical values denote magnitudes of loads applied to the wheels. The numerical values are relative values for the purpose of simple description and do not mean actual loads. The size of the circle surrounding each numerical value is drawn to increase as the numerical value (load) increases. That is, the circle surrounding each numerical value corresponds to a friction circle.

As illustrated in FIG. 4A, when the vehicle 1 travels straight, loads “100” are applied to the front-left wheel 10FL, the front-right wheel 10FR, the rear-left wheel 10RL, and the rear-right wheel 10RR, respectively. Thereafter, it is assumed that the vehicle 1 is turned to right. It is assumed that a load with a magnitude of “40” moves from the right side (the inner wheel side) of the vehicle 1 to the left side (the outer wheel side) by this turning to right. That is, the loads applied to the front-left wheel 10FL and the rear-left wheel 10RL on the outer wheel side increase by “40” in total. On the other hand, the loads applied to the front-right wheel 10FR and the rear-right wheel 10RR on the inner wheel side decrease by “40” in total.

(1) Case of RSf=RSr

First, a case in which the roll stiffness RSf on the front wheels 10F side and the roll stiffness RSr on the rear wheels 10R side are the same is considered with reference to FIG. 4B. In this case, the increase “40” in the load on the outer wheel side is evenly distributed to the front-left wheel 10FL and the rear-left wheel 10RL. Accordingly, the loads applied to the front-left wheel 10FL and the rear-left wheel 10RL increase by “20” and become “120.” On the other hand, the loads applied to the front-right wheel 10FR and the rear-right wheel 10RR on the inner wheel side decrease by “20” and become “80.” The total load applied to the front wheels 10F and the total load applied to the rear wheels 10R are “200,” respectively, which is the same as at the time of traveling straight.

(2) Case of RSf<RSr

Then, a case in which the roll stiffness RSr on the rear wheels 10R side is higher than the roll stiffness RSf on the front wheels 10F side is considered with reference to FIG. 4C. In this case, the increase “40” in the load on the outer wheel side is distributed to the front-left wheel 10FL and the rear-left wheel 10RL in accordance with the ratio of RSf and RSr. For example, a case of RSr/RSf=3 is assumed. In this case, the load applied to the rear-left wheel 10RL increases by “30” and becomes “130,” and the load applied to the front-left wheel 10FL increase by “10” and becomes “110.” On the other hand, the load applied to the rear-right wheel 10RF on the inner wheel side decreases by “30” and becomes “70,” and the load applied to the front-right wheel 10FR decreases by “10” and becomes “90.” The total load applied to the front wheels 10F and the total load applied to the rear wheels 10R are “200,” respectively, which is the same as at the time of traveling straight.

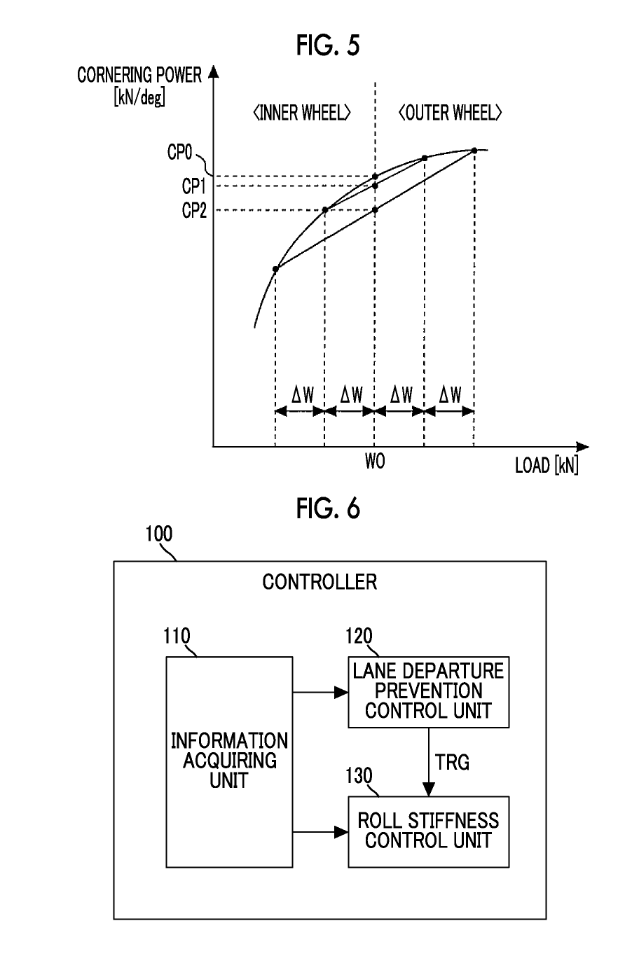

A difference in steering characteristics is present between the case of (1) and the case of (2). This will be described below with reference to FIG. 5. FIG. 5 is a graph illustrating a relationship between a cornering power and a load. The horizontal axis represents a load [kN] applied to a certain wheel, and the vertical axis represents a cornering power [kN/deg] of the wheel. For example, when a load W0 is applied to a certain wheel, the cornering power of the wheel is CP0.

As known well, the cornering power varies depending on the load and increases as the load increases. A ratio of an increase in the cornering power to an increase in the load decreases as the load increases. That is, as illustrated in FIG. 5, the curve illustrating a relationship between the cornering power and the load is convex upward.

Here, an average cornering power of the rear wheels 10R (the rear-left wheel 10RL and the rear-right wheel 10RR) will be considered. It is assumed that the vehicle 1 is turned to right, a load W0+ΔW is applied to the rear-left wheel 10RL on the outer wheel side, and a load W0−ΔW is applied to the rear-right wheel 10RR on the inner wheel side. The average cornering power of the rear wheels 10R in this case is CP1 which is lower than CP0 as can be seen from FIG. 5.

Then, it is assumed that a load W0+2ΔW is applied to the rear-left wheel 10RL on the outer wheel side and a load W0−2ΔW is applied to the rear-right wheel 10RR on the inner wheel side. The average cornering power of the rear wheels 10R in this case is CP2 which is lower than CP1 as can be seen from FIG. 5. That is, when the vehicle is turned, the average cornering power of the inner wheel and the outer wheel decreases as the difference in load between the inner wheel and the outer wheel increases. On the other hand, the average cornering power of the inner wheel and the outer wheel increases as the difference in load between the inner wheel and the outer wheel decreases.

FIGS. 4B and 4C are compared. That is, the case of (1) and the case of (2) are compared. Paying attention to the rear wheels 10R, the difference in load between the rear-left wheel 10RL and the rear-right wheel 10RR is “40 (=120−80)” in the case of (1) and is “60 (=130−70)” in the case of (2). Accordingly, the average cornering power of the rear wheels 10R is lower in the case of (2) than in the case of (1).

On the other hand, paying attention to the front wheels 10F, the difference in load between the front-left wheel 10FL and the front-right wheel 10FR is “40 (=120−80)” in the case of (1) and is “20 (=110−90)” in the case of (2). Accordingly, the average cornering power of the front wheels 10F is higher in the case of (2) than in the case of (1).

In this way, in comparison with the case of (1), the average cornering power in the case of (2) decreases in the rear wheels 10R and increases in the front wheel 10F. This means that an over-steering tendency is stronger in the case of (2). That is, the over-steering tendency become stronger as the roll stiffness distribution to the rear wheels 10R becomes larger.

A “rear distribution ratio RSr/RSf” is considered as an example of a parameter indicating the roll stiffness distribution to the rear wheels 10R. The rear distribution ratio RSr/RSf is a ratio of the roll stiffness RSr on the rear wheels 10R side to the roll stiffness RSf on the front wheels 10F side. As the rear distribution ratio RSr/RSf increases, the over-steering tendency increases. On the other hand, as the rear distribution ratio RSr/RSf decreases, an under-steering tendency increases.

In this way, by changing the roll stiffness RSf and RSr of the vehicle 1, it is possible to change the steering characteristics of the vehicle 1. The controller 100 according to this embodiment executes the “roll stiffness control” of changing the roll stiffness RSf and RSr. When the roll stiffness RSf and RSr change, the controller 100 can activate the actuators 42F and 42R of the roll stiffness varying mechanism 40. Accordingly, the controller 100 and the roll stiffness varying mechanism 40 can be said to constitute a “roll stiffness control device” that executes the roll stiffness control.

### 4. Interlinking of Lane Departure Prevention Control and Roll Stiffness Control

FIG. 6 is a block diagram illustrating the functions of the controller 100 according to this embodiment. The controller 100 includes an information acquiring unit 110, a lane departure prevention control unit 120, and a roll stiffness control unit 130 as functional blocks. These functional blocks are realized by causing the processor of the controller 100 to execute the control program stored in the memory.

The information acquiring unit 110 receives traveling information from various sensors mounted in the vehicle 1. The traveling information includes rotation speeds of the wheels detected by the wheel speed sensor 50, a steering angle detected by the steering angle sensor 52, a vehicle speed detected by the vehicle speed sensor 54, a lateral acceleration detected by the lateral acceleration sensor 56, and an actual yaw rate detected by the yaw rate sensor 58. The information acquiring unit 110 receives traveling lane information from the camera unit 60. The process of the information acquiring unit 110 corresponds to Step S1 in FIG. 3.

The lane departure prevention control unit 120 receives the traveling information and the traveling lane information from the information acquiring unit 110. The lane departure prevention control unit 120 determines whether the lane departure prevention control should be executed based on the traveling information and the traveling lane information (Step S2 in FIG. 3). When it is determined that the lane departure prevention control should be executed, the lane departure prevention control unit 120 executes the lane departure prevention control (Step S3 in FIG. 3).

The roll stiffness control unit 130 executes the roll stiffness control and changes the roll stiffness RSf and RSr. One feature of this embodiment is that the roll stiffness control unit 130 executes the roll stiffness control coupling with execution of the lane departure prevention control. That is, when the lane departure prevention control unit 120 executes the lane departure prevention control, the roll stiffness control unit 130 executes the roll stiffness control in response to execution of the lane departure prevention control. Here, “in response to the execution of the lane departure prevention control” includes both concepts of “in response to the determination (YES in Step S2 in FIG. 3) of execution of the lane departure prevention control” and “in response to “start” (Step S3 in FIG. 3) of execution of the lane departure prevention control.”

The roll stiffness control according to this embodiment can be said to be triggered directly by execution of the lane departure prevention control. For example, as illustrated in FIG. 6, the lane departure prevention control unit 120 outputs a trigger signal TRG to the roll stiffness control unit 130. The output timing of the trigger signal TRG may be a time at which execution of the lane departure prevention control is determined (YES in Step S2) or a time at which execution of the lane departure prevention control is started (Step S3). In any case, the trigger signal TRG is output directly due to execution of the lane departure prevention control. The roll stiffness control unit 130 receives the trigger signal TRG from the lane departure prevention control unit 120 and executes the roll stiffness control in response to the trigger signal TRG

So long as the roll stiffness control is executed by coupling with the lane departure prevention control, the start time of the roll stiffness control may be earlier than, later than, or the same as the start time of the lane departure prevention control. For example, in a case in which the trigger signal TRG is output when execution of the lane departure prevention control is determined, there is a likelihood that the roll stiffness control will be started before the lane departure prevention control is started.

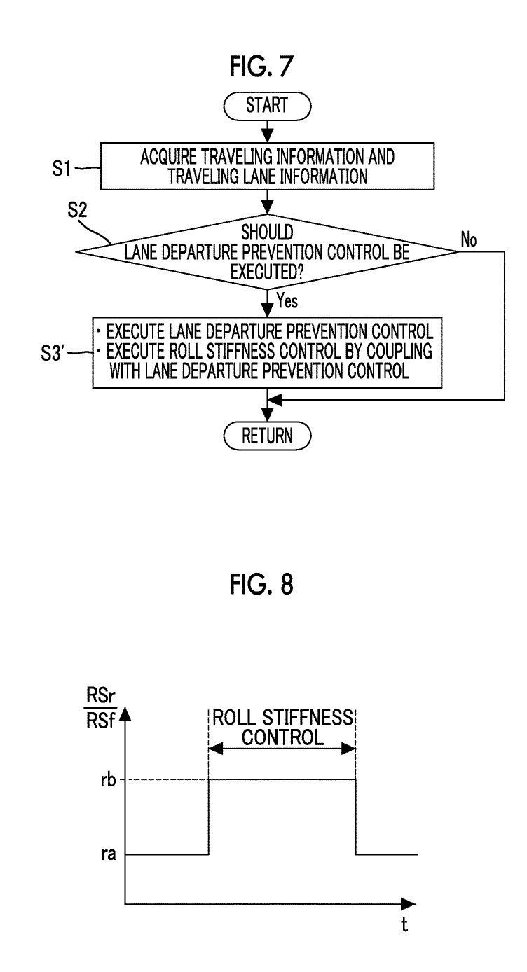

FIG. 7 is a flowchart illustrating a process flow in the controller 100 according to this embodiment in brief. In FIG. 7, an aspect of “interlocking of the roll stiffness control with the lane departure prevention control” is incorporated into the flowchart illustrated in FIG. 3. More specifically, Step S3 in FIG. 3 is replaced with Step S3′. Steps S1 and S2 are the same as in FIG. 3 and detailed description thereof will not be repeated.

Step S3′: The controller 100 executes the lane departure prevention control. Specifically, the controller 100 automatically turns the vehicle 1 in a direction in which lane departure is avoided. The controller 100 executes the roll stiffness control of changing the roll stiffness RSf and RSr by coupling with execution of the lane departure prevention control. When lane departure is avoided and the lane departure prevention control is completed, the controller 100 ends the roll stiffness control and returns the roll stiffness RSf and RSr to the states before the roll stiffness control is started.

As described above, according to this embodiment, the roll stiffness control is executed by coupling with the lane departure prevention control. The lane departure prevention control turns the vehicle 1 and the roll stiffness control affects the steering characteristics of the vehicle 1. Accordingly, by combining the roll stiffness control with the lane departure prevention control, it is possible to control behavior of the vehicle 1 more finely than in existing lane departure prevention control. Hereinafter, various examples of traveling control based on the combination of the lane departure prevention control and the roll stiffness control will be described.

### 5. Various Examples of Traveling Control

### 5-1. First Example

The lane departure prevention control is executed regardless of a driver's intention and thus causes discomfort to the driver depending on situations. For example, in a case of the lane departure prevention control based on the brake control, even when a driver does not depress the brake pedal 32, the vehicle 1 is decelerated. The deceleration gives discomfort to the driver. In a case of the lane departure prevention control based on application of a steering torque, the steering torque is transmitted to a driver's hand gripping the steering wheel 22. The driver feels a torque different from a road-surface reaction force, which causes discomfort. The first example relates to traveling control that can reduce such discomfort.

FIG. 8 is a timing chart illustrating the roll stiffness control in the first example. In FIG. 8, the horizontal axis represents time and the vertical axis represents the rear distribution ratio RSr/RSf. According to this example, the controller 100 increases the rear distribution ratio RSr/RSf by coupling with execution of the lane departure prevention control. For example, in FIG. 8, the rear distribution ratio RSr/RSf before the roll stiffness control is executed is ra. The controller 100 sets the rear distribution ratio RSr/RSf to rb which is higher than ra in the roll stiffness control.

As described above with reference to FIGS. 4A to 4C, the over-steering tendency increases as the rear distribution ratio RSr/RSf increases. The increase of the over-steering tendency means that the vehicle 1 is more easily turned by the lane departure prevention control. That is, by increasing the rear distribution ratio RSr/RSf by coupling with the lane departure prevention control, the vehicle 1 can be more easily turned.

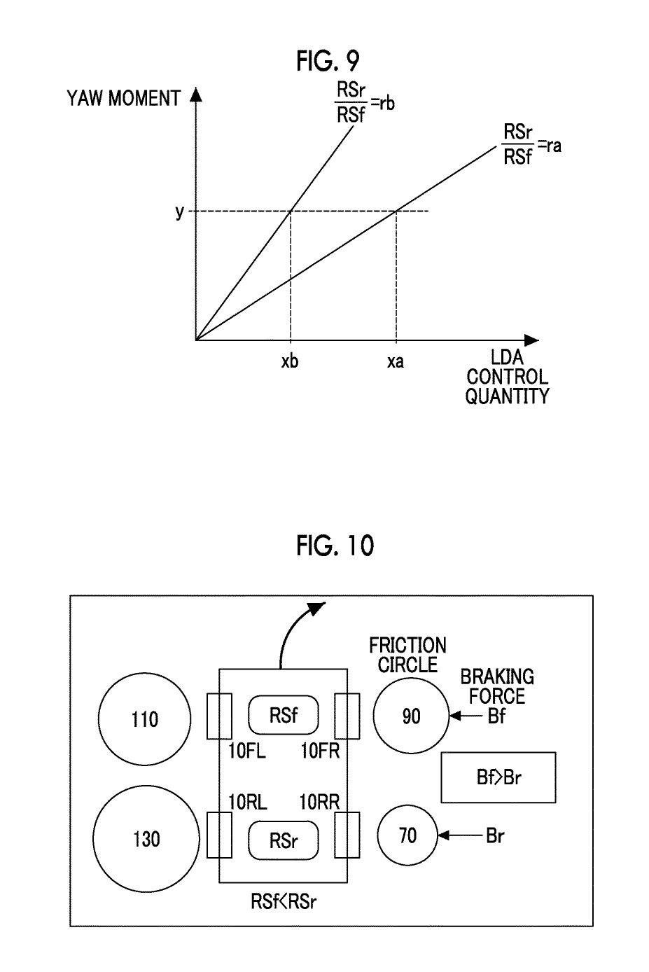

FIG. 9 is a conceptual diagram illustrating advantages which are achieved in the example. In FIG. 9, the horizontal axis represents LDA control quantity and the vertical axis represents yaw moment which is generated by the lane departure prevention control. Here, the LDA control quantity is a parameter which reflects a quantity of control which is performed by the lane departure prevention control. In a case of the lane departure prevention control based on the brake control, the LDA control quantity is a parameter based on the braking force applied to the wheels. In a case of the lane departure prevention control based on application of a steering torque, the LDA control quantity is a parameter based on the applied steering torque.

In a case of RSr/RSf=ra, the LDA control quantity required for generating the yaw moment y is xa. On the other hand, in a case of RSr/RSf=rb (>ra), the over-steering tendency increases and the vehicle 1 is more easily turned. In this case, the LDA control quantity required for generating the same yaw moment y is xb which is smaller than xa. That is, by increasing the rear distribution ratio RSr/RSf, it is possible to suppress the LDA control quantity. When the LDA control quantity (a braking force, a steering torque) decreases, discomfort due to the lane departure prevention control is reduced by as much.

In this example, the roll stiffness control is executed to assist turning of the vehicle 1 by the lane departure prevention control. Accordingly, a burden of the lane departure prevention control is reduced and the LDA control quantity decreases. As a result, it is possible to reduce discomfort due to the lane departure prevention control.

### 5-2. Second Example

A second example is a modification of the first example and is applied particularly to the lane departure prevention control based on the brake control.

FIG. 10 is a conceptual diagram illustrating the lane departure prevention control according to the second example. It is assumed that the vehicle 1 is turned to right by the lane departure prevention control based on the brake control. In this case, for example, the controller 100 applies a front-wheel braking force Bf and a rear-wheel braking force Br to the front-right wheel 10FR and the rear-right wheel 10RR, respectively, on the turning side.

On the other hand, the rear distribution ratio RSr/RSf is increased by the roll stiffness control described in the first example. As can be seen from comparison of FIG. 4A (RSf=RSr) and FIG. 4B (RSf<RSr), when the rear distribution ratio RSr/RSf increases, the friction circle of the front-right wheel 10FR is enlarged and the friction circle of the rear-right wheel 10RR is reduced. Accordingly, when the rear-wheel braking force Br is applied, the rear-right wheel 10RR slips more easily. When an amount of slip of the rear-right wheel 10RR increases, a lateral force (a turning force) of the rear wheels 10R as a whole decreases and there is a likelihood that the direction of the vehicle 1 will be changed more than supposed. In other words, there is a likelihood that the lane departure prevention control will not be executed as supposed.

Therefore, the controller 100 adjusts distribution of the front-wheel braking force Bf and the rear-wheel braking force Br to suppress slip of the rear-right wheel 10RR. Specifically, as illustrated in FIG. 10, the controller 100 sets the rear-wheel braking force Br to be smaller than the front-wheel braking force Bf (Bf>Br). That is, regarding the rear-right wheel 10RR having a relatively small friction circle, the rear-wheel braking force Br is set to be relatively small in order to suppress slip. On the other hand, in order to maintain the total braking force, the front-wheel braking force Bf of the front-right wheel 10FR having a relatively large friction circle is set to be relatively large. By this braking force distribution adjustment, it is possible to maintain the total braking force and to suppress slip. As a result, it is possible to stably execute the lane departure prevention control.

The braking force distribution adjustment according to this example has only to be performed in at least a partial period during the lane departure prevention control (the brake control). Even when the braking force distribution adjustment is performed in the partial period, the effect of stabilization of the lane departure prevention control is achieved.

### 5-3. Third Example

A third example is a modification of the second example. As described in the second example, when the amount of slip of the rear-right wheel 10RR increases, the lateral force (the turning force) of the rear wheels 10R as a whole decreases and there is a likelihood that the direction of the vehicle 1 will be changed more than supposed. In the third example, the vehicle 1 is more rapidly turned reversely using the increase in the turning force due to slip of the rear-right wheel 10RR.

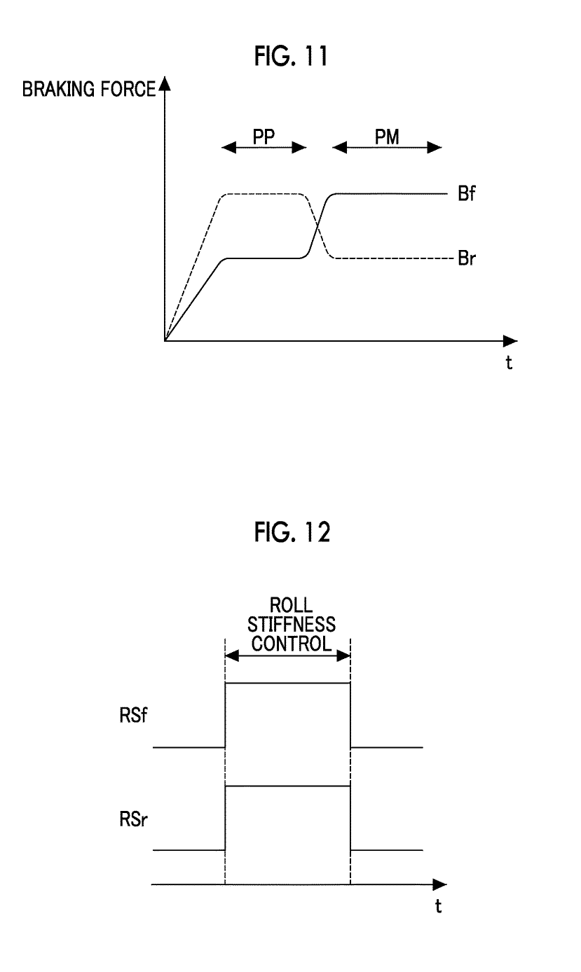

FIG. 11 is a timing chart illustrating lane departure prevention control (brake control) according to the third example. Particularly, FIG. 11 illustrates switching of distribution of the front-wheel braking force Bf and the rear-wheel braking force Br in the brake control. In FIG. 11, a brake control period includes an initial distribution adjustment period PP and a main distribution adjustment period PM. The initial distribution adjustment period PP is an initial stage of the brake control. The main distribution adjustment period PM is a period subsequent to the initial distribution adjustment period PP.

In the initial distribution adjustment period PP, the controller 100 sets the rear-wheel braking force Br to be larger than the front-wheel braking force Bf (Bf<Br). Since the friction circle of the rear-right wheel 10RR is small, the rear-right wheel 10RR slips likely when the large rear-wheel braking force Br is applied thereto. When the amount of slip of the rear-right wheel 10RR increases, the lateral force (the turning force) of the rear wheels 10R as a whole decreases and the yaw moment increases. Accordingly, the vehicle 1 is early turned. The braking force distribution adjustment (Bf<Br) in the initial distribution adjustment period PP can be said to enhance initial responsiveness of the lane departure prevention control.

In the main distribution adjustment period PM subsequent to the initial distribution adjustment period PP, the controller 100 sets the rear-wheel braking force Br to be smaller than the front-wheel braking force Bf (Bf>Br). This braking force distribution adjustment is the same as in the second example and stabilizes the lane departure prevention control.

According to this example, it is possible to stably execute the lane departure prevention control and to enhance initial responsiveness. When the initial distribution adjustment period PP is excessively long, there is concern that the vehicle 1 spins due to the increase in the amount of slip of the rear-right wheel 10RR. Accordingly, the initial distribution adjustment period PP is set to such an extent that the vehicle does not spin.

For example, a transition time from the initial distribution adjustment period PP and the main distribution adjustment period PM is determined based on whether the amount of slip of the rear-right wheel 10RR is greater than a threshold value. Specifically, the controller 100 calculates the amounts of slip (slip ratios) of the wheels based on the rotation speeds of the wheels and the speed of the vehicle 1. The rotation speeds of the wheels are detected by the wheel speed sensors 50FL, 50FR, 50RL, and 50RR. The vehicle speed of the vehicle 1 is detected by the vehicle speed sensor 54. Alternatively, the speed of the vehicle 1 may be calculated from the rotation speeds of the front-left wheel 10FL, the front-right wheel 10FR, the rear-left wheel 10RL, and the rear-right wheel 10RR. The controller 100 monitors an amount of slip of the rear-right wheel 10RR in the initial distribution adjustment period PP, and compares the amount of slip with a threshold value. The threshold value is set to such an amount of slip that the vehicle 1 does not spin. When the amount of slip of the rear-right wheel 10RR is greater than the threshold value, the controller 100 switches the braking force distribution adjustment from “Bf<Br” to “Bf>Br.” Accordingly, it is possible to enhance initial responsiveness of the lane departure prevention control within a range in which the vehicle 1 does not spin.

### 5-4. Fourth Example

When a degree of turning of the vehicle 1 increases by the lane departure prevention control, the lateral acceleration and the roll angle increase. A driver feels roll behavior which does not correspond to steering, which causes discomfort. A fourth example relates to traveling control that can reduce such discomfort.

FIG. 12 is a timing chart illustrating roll stiffness control in the fourth example. According to this example, the controller 100 increases both the roll stiffness RSf of the front wheels 10F side and the roll stiffness RSr of the rear wheels 10R side by interlinking with execution of the lane departure prevention control. Accordingly, an increase in roll angle at the time of the lane departure prevention control is suppressed. As a result, it is possible to reduce discomfort due to the increase in roll angle.

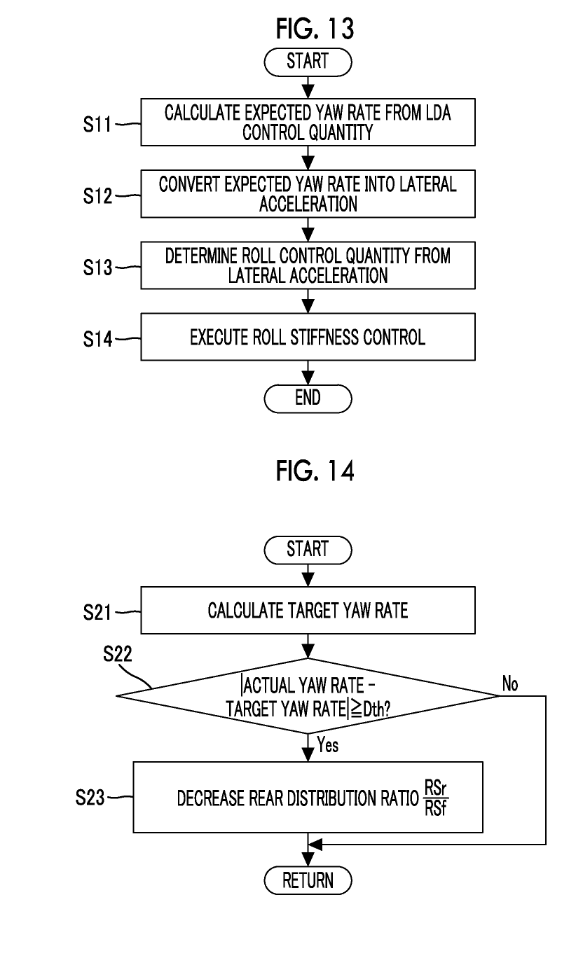

FIG. 13 is a flowchart illustrating the roll stiffness control in this example. After the LDA control quantity (a braking force, a steering torque) by the lane departure prevention control is determined, the controller 100 calculates an expected yaw rate which is expected to be generated by the LDA control quantity (Step S11). Subsequently, the controller 100 converts the expected yaw rate into a lateral acceleration (Step S12). Then, the controller 100 determines a roll control quantity with a magnitude corresponding to the calculated lateral acceleration (Step S13). Here, the roll control quantity is an increase in roll stiffness RSf and RSr in the roll stiffness control according to this example. The roll control quantity is determined to increase as the lateral acceleration (the expected yaw rate) increases. Thereafter, the controller 100 executes the roll stiffness control using the determined roll control quantity (Step S14).

As another example of the method of determining the roll control quantity, a method using an actual lateral acceleration which is detected by the lateral acceleration sensor 56 can be used. That is, when the lane departure prevention control is executed, the vehicle 1 is turned and the lateral acceleration increases. Thereafter, the controller 100 determines the roll control quantity based on the actual lateral acceleration detected by the lateral acceleration sensor 56. However, in this method, the time at which the roll control quantity is determined is after the lateral acceleration and the roll angle increase actually. That is, the roll angle first increases once and then decreases by the roll stiffness control.

On the other hand, in the method illustrated in FIG. 13, the roll control quantity is determined from the LDA control quantity in a feedforward manner. Accordingly, in comparison with the method using the lateral acceleration sensor 56, it is possible to determine the roll control quantity earlier and to start the roll stiffness control earlier. Accordingly, it is possible to prevent an increase in roll angle in the initial stage and to realize more smooth behavior.

### 5-5. Fifth Example

The vehicle 1 is turned by the lane departure prevention control. However, when the degree of turning at this time is great and the vehicle 1 is in an over-steering state, a driver also feels discomfort. The fifth example relates to traveling control that can reduce such discomfort.

FIG. 14 is a flowchart illustrating roll stiffness control according to the fifth example. After the lane departure prevention control is started, the controller 100 determines whether the vehicle 1 is in an over-steering state. More specifically, the followings are performed.

Step S21: In the lane departure prevention control based on application of a steering torque, the controller 100 calculates a target yaw rate using a known method based on the steering angle and the vehicle speed. The steering angle is detected by the steering angle sensor 52. The vehicle speed is detected by the vehicle speed sensor 54. Alternatively, the vehicle speed may be calculated by the rotation speeds of the front-left wheel 10FL, the front-right wheel 10FR, the rear-left wheel 10RL, and the rear-right wheel 10RR which are detected by the wheel speed sensors 50FL, 50FR, 50RL, and 50RR.

In the lane departure prevention control based on brake control, since the steering angle does not vary, the steering angle cannot be used to calculate the target yaw rate. Therefore, the LDA control quantity (a braking force) is used instead of the steering angle. The controller 100 calculates the target yaw rate based on the LDA control quantity or the vehicle speed. For example, a map indicating a relationship between the LDA control quantity and the target yaw rate is prepared in advance. After the LDA control quantity in the brake control is determined, the controller 100 acquires the target yaw rate based on the map.

Step S22: Then, the controller 100 calculates a yaw rate deviation by subtracting the target yaw rate from an actual yaw rate. The actual yaw rate is detected by the yaw rate sensor 58. Then, the controller 100 compares the yaw rate deviation with a threshold value Dth. When the yaw rate deviation is equal to or greater than the threshold value Dth (YES in Step S22), the controller 100 determines that the vehicle 1 is in the over-steering state. In this case, the process flow transitions to Step S23. On the other hand, when the yaw rate deviation is less than the threshold value Dth (NO in Step S22), this cycle ends.

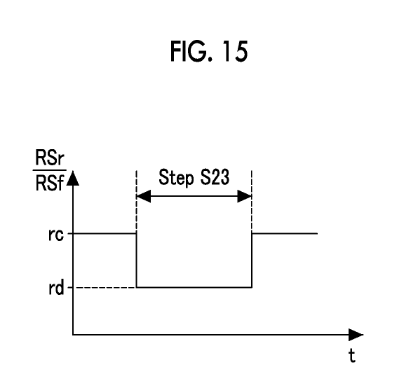

Step S23: The controller 100 decreases the rear distribution ratio RSr/RSf. FIG. 15 is a timing chart illustrating the process of Step S23. In FIG. 15, the horizontal axis represents time, and the vertical axis represents rear distribution ratio RSr/RSf. Here, rc denotes the rear distribution ratio RSr/RSf before the roll stiffness control is executed. In Step S23, the controller 100 sets the rear distribution ratio RSr/RSf to rd which is lower than rc.

As described above with reference to FIGS. 4A to 4C, as the rear distribution ratio RSr/RSf decreases, the under-steering tendency increases. Accordingly, over-steering behavior due to the lane departure prevention control is relaxed. As a result, it is possible to reduce discomfort given to a driver.

As long as they are consistent with each other, the first to fifth examples can be appropriately combined.

What is claimed is:

1. A vehicle controller comprising:
at least one electronic control unit configured to execute:
lane departure prevention control of controlling a first actuator such that a vehicle is turned in a direction in which lane departure of the vehicle is avoided; and
roll stiffness control of controlling a second actuator such that a roll stiffness of the vehicle is changed,
wherein the at least one electronic control unit executes the roll stiffness control by coupling with execution of the lane departure prevention control.

2. The vehicle controller according to claim 1, wherein
the roll stiffness of the vehicle includes a first roll stiffness that is a roll stiffness of a front-wheel side and a second roll stiffness that is a roll stiffness of a rear-wheel side, and
the at least one electronic control unit increases a rear distribution ratio, which is a ratio of the second roll stiffness to the first roll stiffness, in the roll stiffness control in comparison with the rear distribution ratio before execution of the roll stiffness control is started.

3. The vehicle controller according to claim 2, wherein
the first actuator is a brake device that generates a difference in a braking force between right and left wheels of the vehicle to change a direction of the vehicle, and
in the lane departure prevention control, the at least one electronic control unit performs control of providing a front-wheel braking force to a front inner wheel of the vehicle and providing a rear-wheel braking force to a rear inner wheel of the vehicle and the at least one electronic control unit performs first braking force distribution adjustment of performing control of setting the rear-wheel braking force to be smaller than the front-wheel braking force in a first period in the brake control.

4. The vehicle controller according to claim 3, wherein
the at least one electronic control unit performs second braking force distribution adjustment in a second period that is prior to the first period in the brake control, the second braking force distribution adjustment is a control of setting the rear-wheel braking force to be larger than the front-wheel braking force.

5. The vehicle controller according to claim 4, wherein
the at least one electronic control unit monitors an amount of slip of the rear wheel in the second period and switches performance from the second braking force distribution adjustment to the first braking force distribution adjustment when the amount of slip is greater than a threshold value.

6. The vehicle controller according to claim 1, wherein
the roll stiffness of the vehicle includes a first roll stiffness that is a roll stiffness of a front-wheel side and a second roll stiffness that is a roll stiffness of a rear-wheel side, and
the at least one electronic control unit controls the second actuator such that both the second roll stiffness and the first roll stiffness are greater than those before the roll stiffness control is executed in the roll stiffness control.

7. The vehicle controller according to claim 6, wherein
the at least one electronic control unit calculates an expected yaw rate which is expected to be generated by the lane departure prevention control and determines an increase in both the first roll stiffness and the second roll stiffness based on the expected yaw rate.

8. The vehicle controller according to claim 1, wherein
the roll stiffness of the vehicle includes a first roll stiffness that is a roll stiffness of a front-wheel side and a second roll stiffness that is a roll stiffness of a rear-wheel side, and
the at least one electronic control unit determines whether the vehicle is in an over-steering state after the lane departure prevention control is started and controls the second actuator such that a rear distribution ratio which is a ratio of the second roll stiffness to the first roll stiffness is smaller than the rear distribution ratio before the roll stiffness control is executed when it is determined that the vehicle is in the over-steering state.

9. The vehicle controller according to claim 1, wherein
the first actuator is a brake device that generates a braking force in wheels of the vehicle, and
the at least one electronic control unit controls the first actuator such that a difference in the braking force is generated between the right and left wheels of the vehicle to change a direction of the vehicle in the lane departure prevention control.

10. The vehicle controller according to claim 1, wherein
the first actuator is a steering device that generates a steering torque, and
the at least one electronic control unit controls the steering device such that the steering torque is generated to change a direction of the vehicle in the lane departure prevention control.

11. A vehicle comprising:
a lane departure prevention device that executes lane departure prevention control of turning the vehicle in a direction in which lane departure of the vehicle is avoided; and
a roll stiffness control device that executes roll stiffness control of changing a roll stiffness of the vehicle,
wherein the roll stiffness control device executes the roll stiffness control by coupling with execution of the lane departure prevention control by the lane departure prevention device.

12. A control system that executes traveling control of a vehicle, the control system comprising:
a first actuator configured to turn the vehicle;
a second actuator configured to change a roll stiffness of the vehicle; and
at least one electronic control unit configured to
control the first actuator such that the vehicle is turned in a direction in which departure of the vehicle from a traveling lane is avoided, and
control the second actuator by coupling with control of the first actuator.

13. The vehicle controller according to claim 12,
wherein the first actuator is a brake device that generates a braking force in wheels of the vehicle, and
the at least one electronic control unit controls the first actuator such that a difference in the braking force is generated between the right and left wheels of the vehicle to change a direction of the vehicle.

14. The vehicle controller according to claim 12,
wherein the first actuator is a steering device that generates a steering torque, and
the at least one electronic control unit controls the steering device such that the steering torque is generated to change a direction of the vehicle.
